(19) United States
(12) Patent Application Publication
(10) Pub. No.: US 2014/0289141 A1
(43) Pub. Date: Sep. 25, 2014

(54) Employment Job Centers with Equal Opportunity Tools

(71) Applicants: George Kolber, Locust, NJ (US); Solito Reyes, Hoboken, NJ (US); Richard Kolber, Locust, NJ (US); Robert D. Pearson, Seaside, NJ (US)

(72) Inventors: George Kolber, Locust, NJ (US); Solito Reyes, Hoboken, NJ (US); Richard Kolber, Locust, NJ (US); Robert D. Pearson, Seaside, NJ (US)

(21) Appl. No.: 13/849,401

(22) Filed: Mar. 22, 2013

(51) Int. Cl. G06Q 10/10

(52) U.S. Cl. CPC G06Q 10/1053
USPC 705/321

(57) ABSTRACT

An employment server in communication over an Internet with a plurality of job candidates and with a plurality of businesses and related methods are disclosed. The web site stores and provides upon request a plurality of job candidate web pages, each have a set of job qualifications. It also stores and provides upon request a plurality of job center web pages. It also stores and provides upon request, a plurality of job details web pages, each one of which is related to a job center web page. When a business reviews the job center web page and the job details web page, information identifying the business is displayed on the web pages. When a third party reviews these web pages, then information identifying the business may or may not be displayed on the web pages, depending on the settings of one or two stealth setting parameters.

### BACKGROUND

Employment is an important part of an economy. For businesses, finding the right candidate to fill jobs at the business is a crucial part of the success of the business. Unfortunately, finding the right candidate is difficult, time consuming and expensive. Failing to find the right candidate is even more costly.

For individuals, finding the right opportunity is very important. Particularly today, it is very hard for individuals to find the right employment opportunities. Existing tools inadequately provide the means for candidates to tell businesses about their capabilities and their qualifications to fulfill job opportunities offered by businesses. These businesses, whether sole proprietorship or the largest corporations, are employers who need to better understand job candidate qualifications.

Existing employment tools provide limited capabilities and are also typically geographically focused and therefore provide restricted employment information. For example, they are generally focused on helping people find jobs in local areas. They do not provide a person seeking a particular job anywhere with adequate tools to find the right job. Likewise, businesses seeking the right employee are similarly limited.

It is also very important for many businesses to comply with employment laws, including but not limited to equal opportunity laws. Existing employment tools either provide no tools to enable compliance with these laws or the tools provided are inadequate.

Accordingly, new and improved systems and methods for providing and fulfilling employment opportunities are needed.

### SUMMARY OF THE INVENTION

Systems and methods for providing an employment web site and a job center for businesses are disclosed.

In accordance with one aspect of the present invention, a method of providing an employment server having a memory that stores a set of qualifications for a plurality of job candidates and a plurality of jobs offered by a business and having a processor that generates a set of job candidates for each of the plurality of jobs, is provided. The processor receives a request from the business for a job candidate search web page that lists the set of job candidates for one of the plurality of jobs and, for each job candidate in the set, displays a set of information about the job candidate. Upon receiving the request, the processor accesses a plurality of employment law controls previously selected by the business that have been stored in the memory and forms the set of information for each job candidate in the set in accordance with the plurality of employment law controls. Then the processor causes the job candidate search results web page to be displayed to the business in accordance with the plurality of employment law controls. In accordance with other aspects of the present invention, the processor can use only one of the plurality of employment law controls to determine the contents of the displayed web page.

One of the plurality of employment law controls can be a name control that the processor uses to determine whether contents of the candidate search results web page that is shown to the business includes a name of any of the plurality of job candidates.

One of the plurality of employment law controls can be a photo control that the processor uses to determine whether contents of the candidate search report web page that is shown to the business includes a photo of any of the plurality of job candidates.

One of the plurality of employment law controls can be a video control that the processor uses to determine whether contents of the candidate search report web page that is shown to the business includes a video of any of the plurality of job candidates.

One of the plurality of employment law controls is an address control that the processor uses to determine whether contents of the candidate search report web page that is shown to the business includes an address of any of the plurality of job candidates.

One of the plurality of employment law controls can be a time control that the processor uses to determine whether contents of the candidate search report web page that is shown to the business includes the name of any of the plurality of job candidates.

The processor can use any one of these employment law controls by itself or in any combination to control the contents of the web page that are shown to the business.

The time control, in accordance with an aspect of the present invention can be set such that the processor causes the photo, the video and the address of any of the plurality of job candidates to be shown to a business only after job candidates are selected for an interview.

In accordance with another aspect of the present invention, the time control can be set such that the processor causes the photo, the video and the address of any of the plurality of job candidates to be shown to a business only after the business pays a fee to view one of the plurality of job candidates.

In accordance with an aspect of the present invention, the set of job candidates for each one of the plurality of jobs includes job candidates that applied for each one of the plurality of jobs. Also, the set of job candidates for each one of the plurality of jobs can also include job candidates that the processor determined are qualified for each one of the plurality of jobs. Further, the set of job candidates for each one of the plurality of jobs can include only job candidates that the processor determined are qualified for each one of the plurality of jobs.

In accordance with other aspects of the present invention, statistics concerning the employment process for each business are determined by the processor and displayed to the business upon request. Further, a system, that includes a processor, a memory and perhaps an Internet interface that performs the methods described herein, is also provided.

### DESCRIPTION OF THE DRAWINGS

FIGS. 1 and 2 illustrate a system for providing an employment web site and employment job centers.

FIGS. 3 and 4 illustrate a memory architecture for the employment web site in accordance with an aspect of the present invention.

FIG. 5 illustrates an opening web page provided to users of the employment web site and the employment job centers provided by the employment web site.

FIG. 6 illustrates an opening web page for businesses using the employment web site.

FIGS. 7-10 illustrate preliminary steps performed by a business wherein a user administrator registers with the employment web site and completes preliminary information to create a job center.

FIG. 11 illustrates a web page that can be displayed once a user administrator registers with the employment web site.

FIG. 12 illustrates a web page that a business uses to enable the web site processor to create a job center web page and a job center.

FIGS. 13 and 14 illustrate a candidate search web page that can be used by a business to create a job posting and a job details web page.

FIG. 15 illustrates a public view of a job center web page having a plurality of job postings listed that has restricted information displayed.

FIG. 16 illustrates a business administrator's view of the business' job center web page.

FIG. 17 illustrates a job details web page.

FIG. 18 illustrates a job candidate web page.

FIGS. 19 to 25 illustrate the job candidate web page of FIG. 14 will all information available.

FIG. 26 illustrates a candidate search result web page that can be displayed to a business' user administrator upon request.

FIG. 27 illustrates a limited view of a job candidate's web page.

FIG. 28 illustrates a public view of a job details web page in the stealth mode.

FIG. 29 illustrates a stealth setting web page for use by job candidates.

FIG. 30 illustrates a web page provided to a business that is creating a job center and a job center web page.

FIG. 31 illustrates the effect of various settings of the equal opportunity employment tools provided to businesses in accordance with an aspect of the present invention.

FIG. 32 also illustrates the effect of various settings of the equal opportunity employment tools provided to businesses in accordance with an aspect of the present invention.

### DESCRIPTION

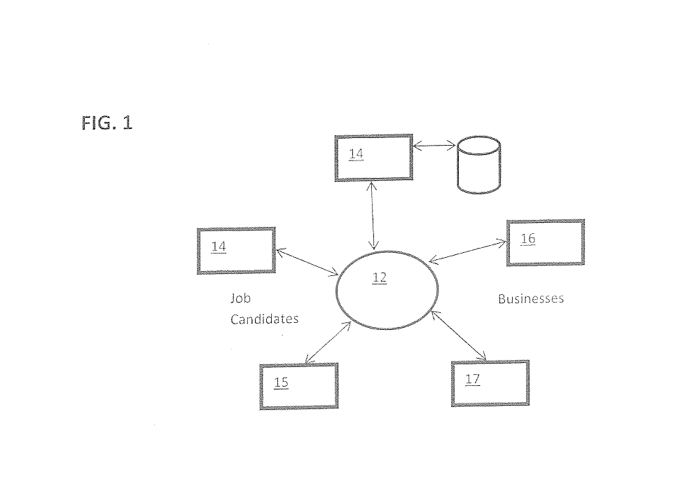

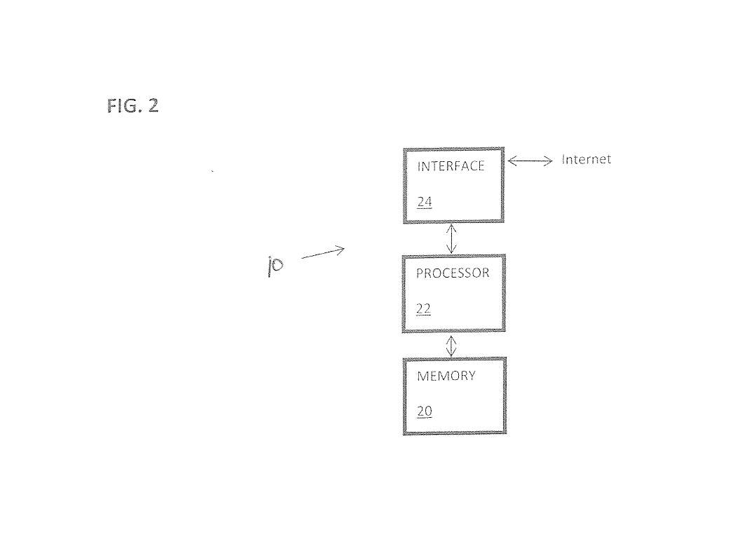

FIGS. 1 and 2 illustrate a system for providing an employment web site and employment job centers in accordance with an aspect of the present invention. FIG. 1 illustrates a connection of the employment system 10 to an Internet 12 and in communication with a plurality of client devices 14-17. The client devices 14-17 are used by a plurality of job candidates each seeking a job and by a plurality of businesses each offering one or more jobs.

FIG. 2 illustrates a hardware architecture of the employment system 10. The employment system includes a memory 20, an interface to the Internet 12 and a processor 22 in communication with the memory 20 and in control of communications over an interface 24 to the Internet 12. The processor 22 is in communication with the memory 20 to store and access information in the memory 20. The processor 22 also controls communications over the interface 24 to the Internet 12. As is normal in server configurations, the processor 22 can be implemented by a plurality of processors, however, for convenience they will be referred to as a single processor.

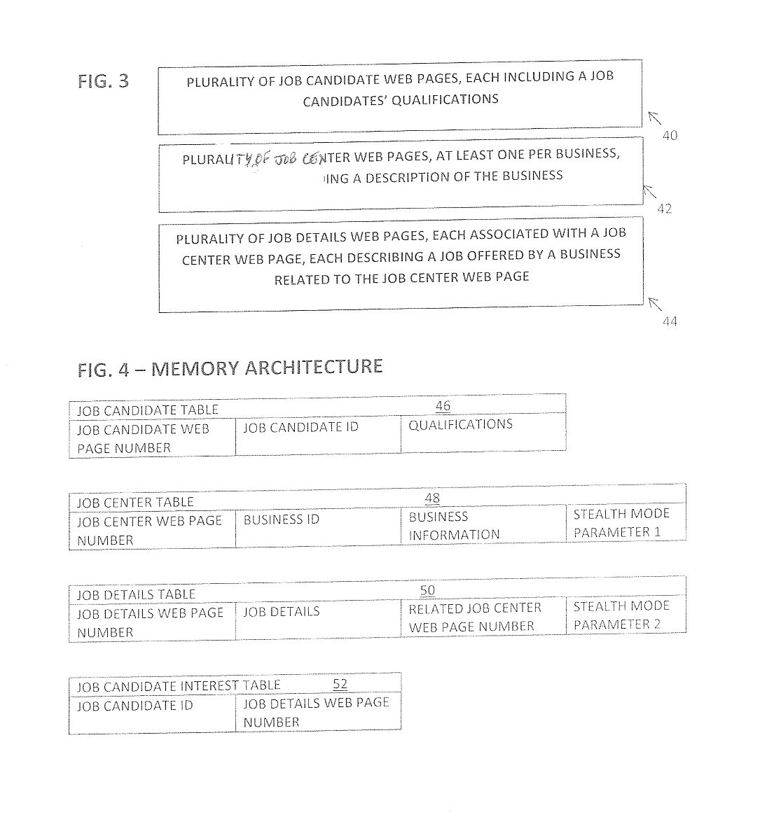

FIG. 3 illustrates the partial contents of the memory 20 of the employment web site and server of the present invention. As illustrated, the memory 20 includes a plurality of job candidate's web pages 40, a plurality of job center web pages 42 and a plurality of job details web pages 44. There is preferably at least one job center web page associated with each one of the plurality of business using the employment web site. Different departments within a business can establish their own job center web page in accordance with an aspect of the present invention, so there can be more than one job center web page associated with each one of the businesses using the employment web site of the present invention. Employers can therefore allow divisions within their businesses to conduct their own searches for job candidates. In accordance with one aspect of the present invention, the job center web page includes information about the business it relates to, including but not limited to a business name, a business logo, a description of the business. In some cases, this information is displayed when the job center web page is displayed along with a listing of available jobs being offered by the business.

One or more job details web pages 44 are associated with each job offered on each job center web page 42. These job details web pages 44 include information about each job offered by a business.

Each job candidate that logs onto the employment web site of the present invention enters job qualification information and creates a job candidate web page that includes the job qualification information. The employment server of the present invention can match a job candidates job qualifications to job opportunities listed in each business' job details web page.

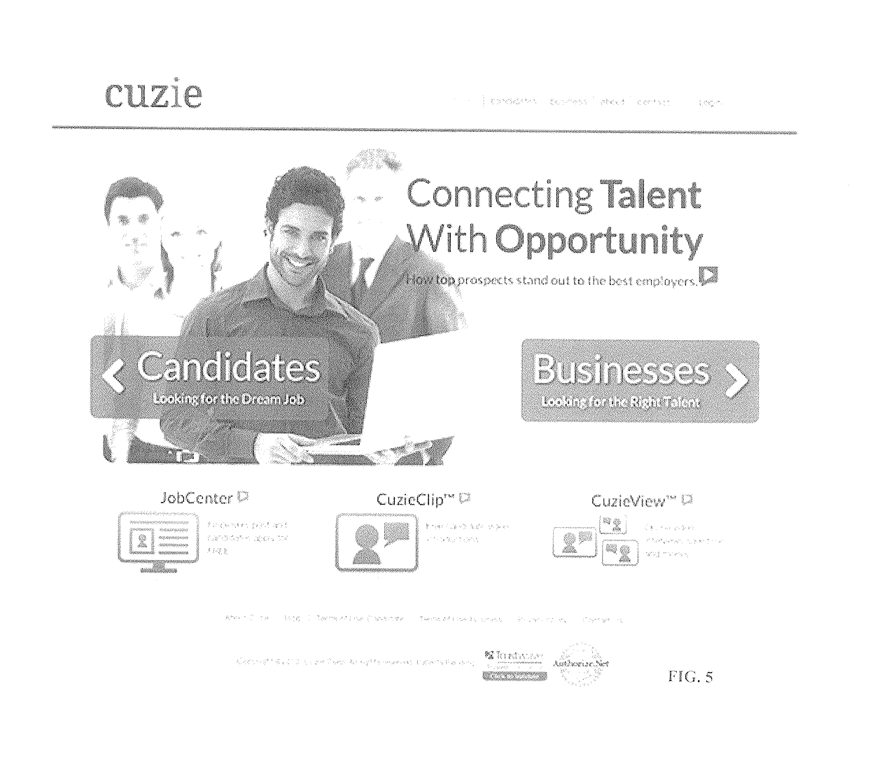

FIG. 4 illustrates a database structure in the memory 20 in accordance with an aspect of the present invention. There are four tables, including a Job Candidate table 46, a Job Center table 48, a Job Details table 50 and a Job Candidate Interest table 52. The Job Candidate table 46 includes several fields, including a Job Candidate Web Page Number, a Job Candidate ID and Qualifications. The Job Candidate Web Page Number identifies a job candidate web page associated with the other fields in the table. The Job Candidate ID identifies each job candidate and the qualifications are the job candidate's qualifications. This table 46 can be implemented in a number of different ways. For example, the Job Candidate ID can be the name of the job candidate or it can point to another table with the job candidate's name in it. Similarly, the Qualification field can be split into a number of fields. For example, it can include a reference to a video clip, education, work experience and the like, which can each be separate fields. The exact implementation of the table or tables is not important.

The Job Center table 48 includes several fields, including a Job Center Web Page Number, a related Business Candidate ID, related Business information and a stealth mode parameter. The Job Center Web Page Number field identifies the job center web page associated with the other fields in the table. The Business ID field identifies the business that created the job center web page. The business information is the information that a business enters to create the job center web page, which will be described later. The business information field can be implemented with a number of fields—one field for each piece of business information. The stealth mode parameter is stored by the processor in the memory for each job center web page to indicate how much information should be included in each of job center web page when it is displayed on a job candidate's or other third party's web access device. The web site processor's use of this parameter will be discussed later.

The Job Details table 50 also includes several fields, including a Job Details Web Page Number, Job Details information, a Related Job Center Web Page Number and a second stealth mode parameter. The Job Details Web Page Number field identifies the job details web page. The Job Details field is the information that a business enters to describe a job, which will be described later. The Job Details field can be implemented with a number of fields—one field for each piece of job information. The Related Job Center Web Page Number identifies the business and the business' job center web page that the job relates to. Each job belongs to one of the job center web pages, and this field is used by the web site processor so that each job can be listed on the job center web page that it belongs to. The stealth mode parameter is stored by the processor in the memory for each job center web page to indicate how much information should be included in each of job center web page when it is displayed on a job candidate's or other third party's web access device. The web site processor's use of this parameter will be discussed later.

The Job Candidate Interest table 52 tracks which job candidates have applied to which job. Every time a job candidate applies to a job, and identifier of the job candidate and an a identifier of the job details web page (preferably by number) is entered into the Job Candidate ID and the Job Details Web Page Number, respectively, in table 52. This allows the web site processor to determine how many and which job candidates have applied for each job.

FIG. 5 illustrates an opening web page provided to users of the employment web site and the employment job centers provided by the employment web site. Thus, when an outside user—Candidate for a job or a Business offering a job—enters the web site shown in FIG. 1, the web page of FIG. 5 is generated by the processor 22 and sent over the Internet 12 to the Candidate or Business. The web page of FIG. 5 is then shown on the display of the device being used by the Candidate or the Business to access the web site. The URL of the web page shown in FIG. 5 is of the form www.xyz.com where “xyz” is the name of the employment web site. For example, CUZIE operates such a web site, which can be found at www.cuzie.com.

Once FIG. 5 is displayed, if the user is a Candidate, the user selects the CANDIDATES button shown in FIG. 5. The web site processor then takes the user to the candidate tools provided by the web site. If the user is a Business, the user selects the BUSINESSES button shown in FIG. 5. The web site processor then takes the user to the business tools provided by the web site.

The web page shown in FIG. 5 also provides three buttons: JOBCENTER, CUZIECLIP and CUZIEVIEW. These are tools provided by the web site. When a user clicks on any of these, a video explaining these tools is shown on the web site.

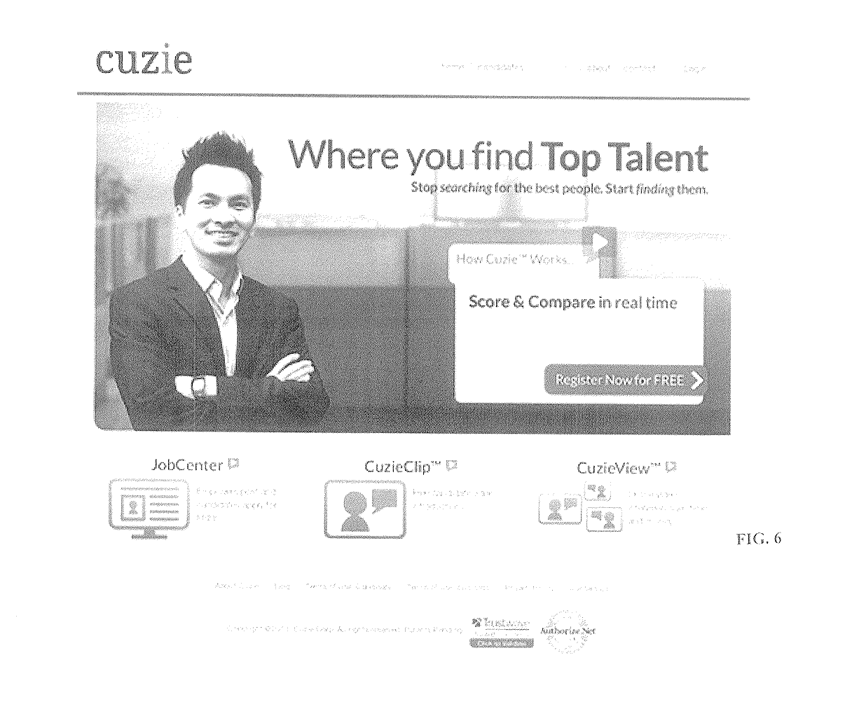

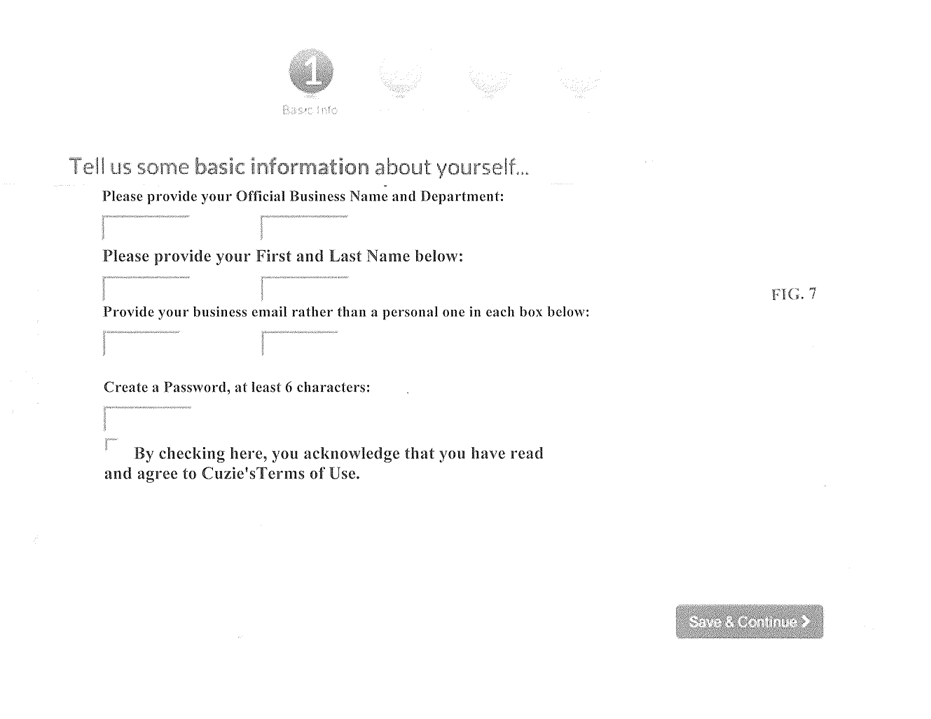

FIG. 6 illustrates an opening web page for businesses using the employment web site of the present invention. This web page opens when the BUSINESSES button shown in FIG. 5 is clicked. Clicking on the REGISTER NOW FOR FREE button starts a process by which the business registers with the web site. As part of the registration process, the business creates a Job Center from which the businesses' job offerings are managed.

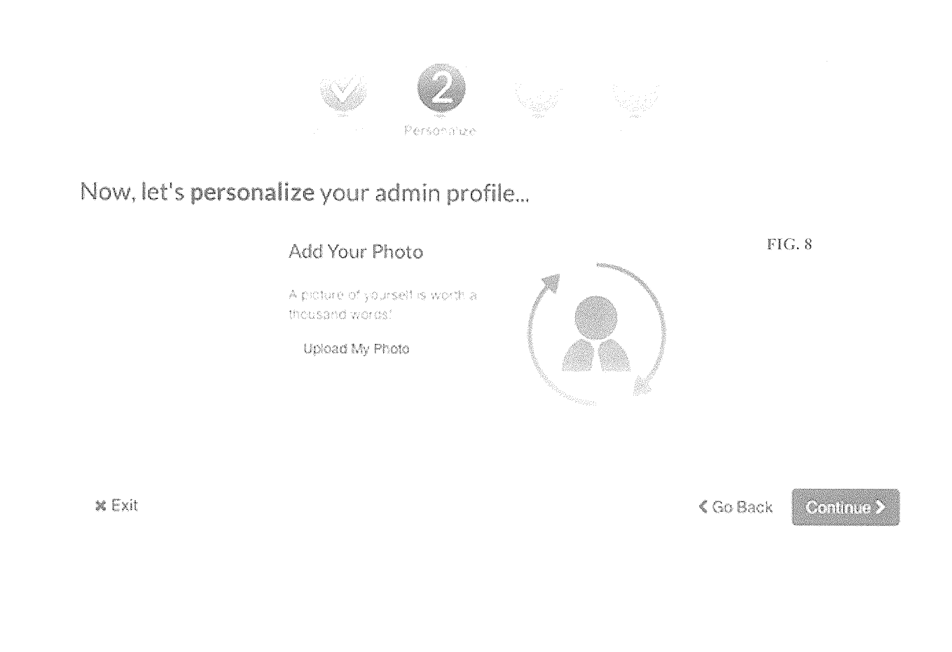

The registration process is illustrated in FIGS. 7-10. The web site processor (which can be more than one processor) causes the web page of FIG. 7 to be sent over the Internet and displayed at the requester's web access device when the REGISTER NOW FOR FREE button is clicked on the web page shown in FIG. 6. The URL associated with the web page of FIG. 6 is preferably of the form “www.xyz.com/wizard/business/one.” The word “business” in the URL, when completed with a name related to the business creating the URL, helps identify the business.

When the web page of FIG. 7 is shown to the user on the internet, it asks the user to provide basic information, including the business name, any business department, the user's first and last names, the user's email and also asks the user to create a password. It also asks the user to verify that the web site's terms and conditions have been read and agreed to. The user enters the information into the web page of FIG. 7 and sends the completed web page to the web site of the present invention. Once received at the web site, the processor(s) of the web site process the information and stores the information in a database in memory associated with the web site. The processor also creates an account for the business.

The web site then causes a web page shown in FIG. 8 to be sent to the user where it is shown to the user on the user's web access device. The URL of the web page of FIG. 8 is preferably of the form www.xyz.com/wizard/organization/two. This web page allows a photograph to be entered and uploaded to the web site server. The photograph is preferably of an administrator or another person who will be the face of the business for the purposes of the employment web site of the present invention. Once FIG. 8 and its associated photo is uploaded to the web site, the web site processor(s) store the photo in a database on the memory. The photo is associated with the account for the business that was just created.

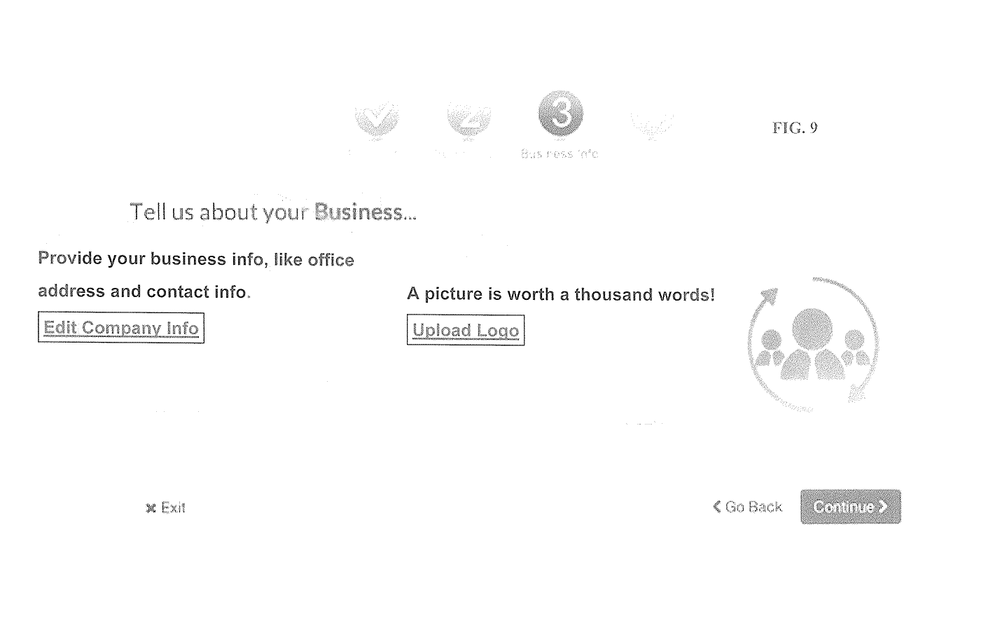

The web site processor then causes a web page shown in FIG. 9 to be sent to the user where it is shown to the user on the user's web access device. The URL of the web page of FIG. 9 is preferably of the form www.xyz.com/wizard/organization/three. This web page allows a company logo to be entered and uploaded to the web site server. It also allows the user to enter information about the business. When the EDIT COMPANY INFO button is selected another web page or other data entry device is displayed to allow the user to enter the business address, phone, email and URL.

Once FIG. 9 and its associated logo is uploaded to the web site, the web site processor(s) store the logo and business information in a database on the memory. The logo is associated with the account for the business that was just created.

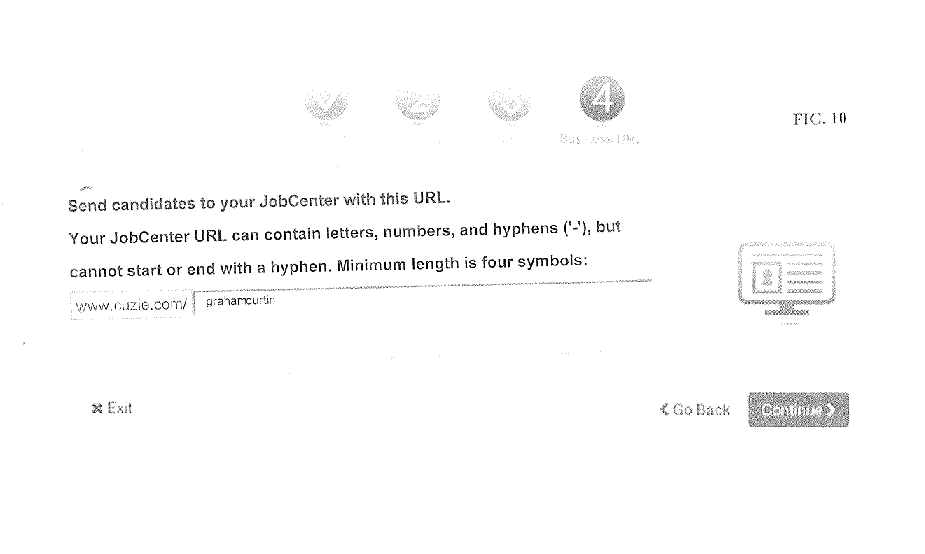

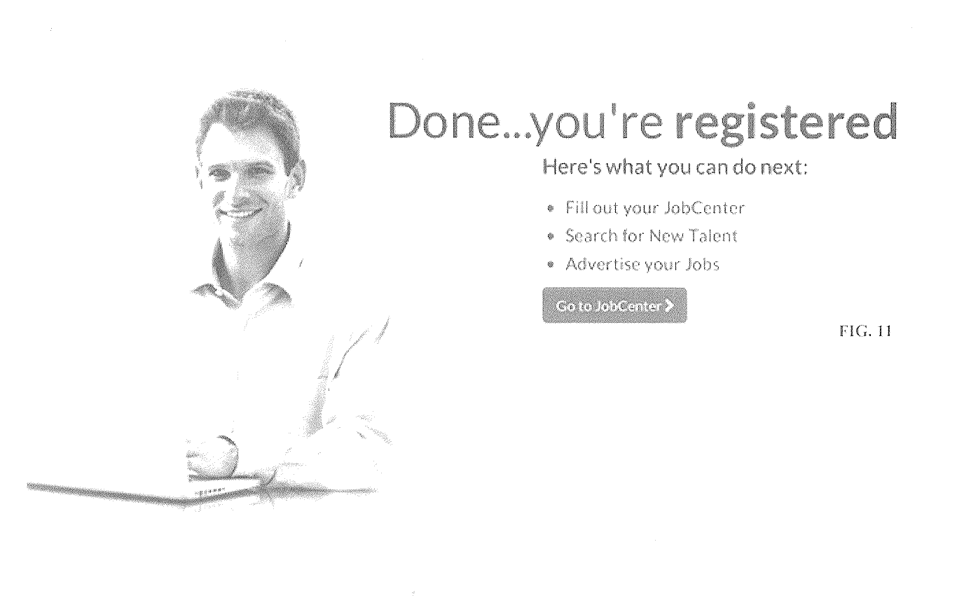

The web site then causes a web page shown in FIG. 10 to be sent to the user where it is shown to the user on the user's web access device. The URL of the web page of FIG. 10 is preferably of the form www.xyz.com/wizard/organization/four. This web page allows a unique URL to be created for the business. The web page of FIG. 10 shows the URL www.xyz.com (in one case the “xyz” in the URL is “cuzie”) and then asks the user to enter a URL that the processor will add to the URL shown to create a unique URL for the business. The user then causes this information to be entered and uploaded to the web site server. Once FIG. 10 and its associated entered URL is uploaded to the web site, the web site processor(s) stores the entered URL in a database on the memory. The URL is associated with the account for the business that was previously created. As an example, the user could enter “abccorp” as its URL. Then the business' unique URL used in the employment web site is www.xyz.com/abccorp. The job center web page for ABC Corp. will be displayed with this URL.

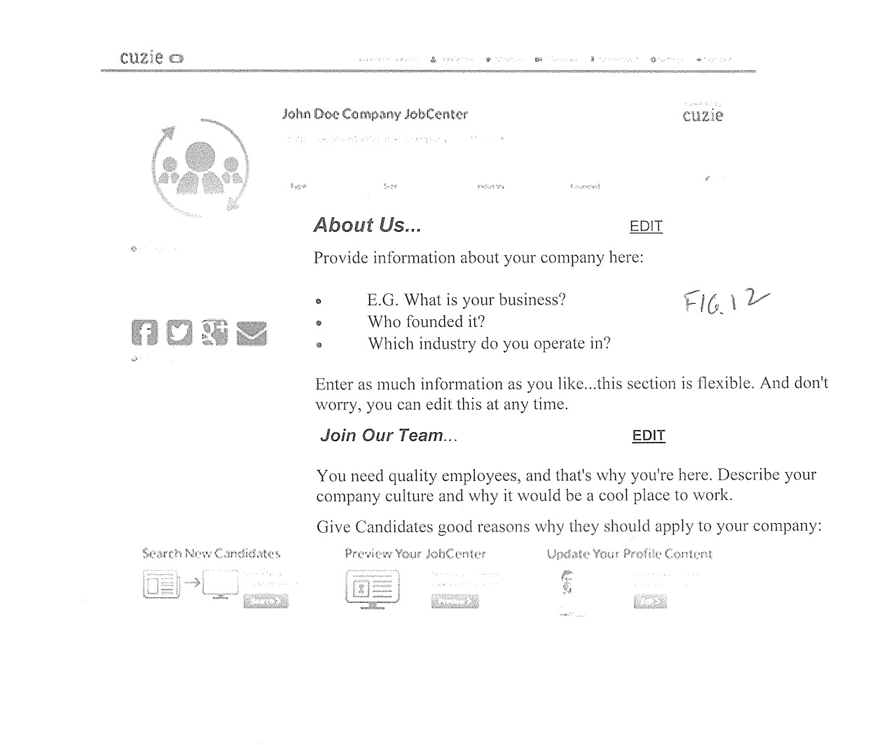

The web site processor then causes a web page shown in FIG. 11 to be sent to the user over the Internet where it is displayed on the user's Internet access device. The web page of FIG. 11 advises the business user that the business is registered. The URL of the web page of FIG. 11 is of the form www.xyz.com/wizard/organization/five.

When the user completed web pages shown in FIGS. 7-10 are submitted to the web site, the web site processor creates a job center web page for the business that just registered. The job center web page includes all of the information just entered, including, but not limited to, the business name, a business logo, a business address, a description of the type of business, a description of what makes the business special and a URL, as previously described. The processor stores the job center web page in memory as previously described.

The web page of FIG. 11 includes a button GO TO JOBCENTER. When this button is clicked, the web site server causes the web page www.xyz.com/abccorp, shown in FIG. 12, to be sent to the user and displayed on the user's web access device. For new users, an in page tutorial showing the more significant features of the job center is shown. The in page tutorial explains, for example, the URL, the logo, business address, business information, candidate search, page preview, profile wizard and the Job Board Section.

The web page of FIG. 12 allows a user to edit the logo, the type of business, the size of the business, the industry of the business, the year the business was founded. It also allows the user to enter an “ABOUT US” statement that describes the business. It also provides a “JOIN OUR TEAM” section where further information about the business culture and reasons why joining the team would be cool, including for example, casual Fridays or any other feature that makes working at the business enjoyable. When this information is entered and the web page submitted to the web site, the web site processor causes the information to be stored in the memory. Both “About Us” and “Join Our Team” sections are defaults but are editable and can be modified, including the titles of same.

At the bottom of the web page of FIG. 12, a user can preview the job center by selecting PREVIEW YOUR JOBCENTER. The user can also update the profile by selecting UPDATE YOUR PROFILE CONTENT. The user can also create a new job by selecting START A CANDIDATE SEARCH.

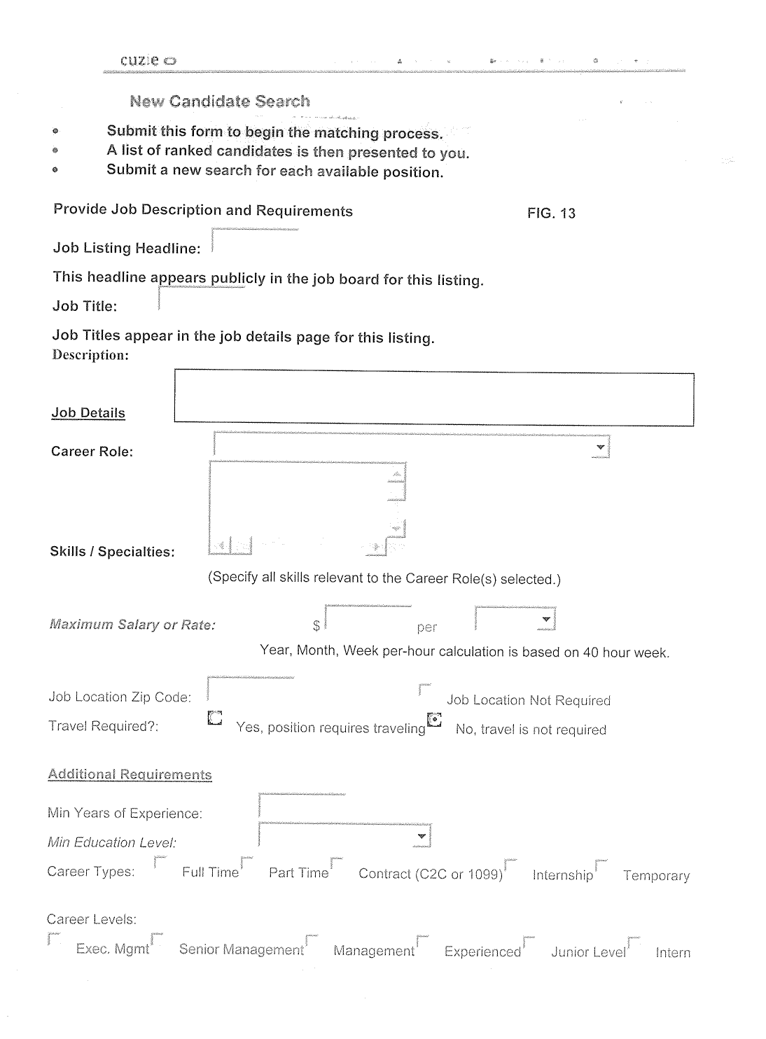

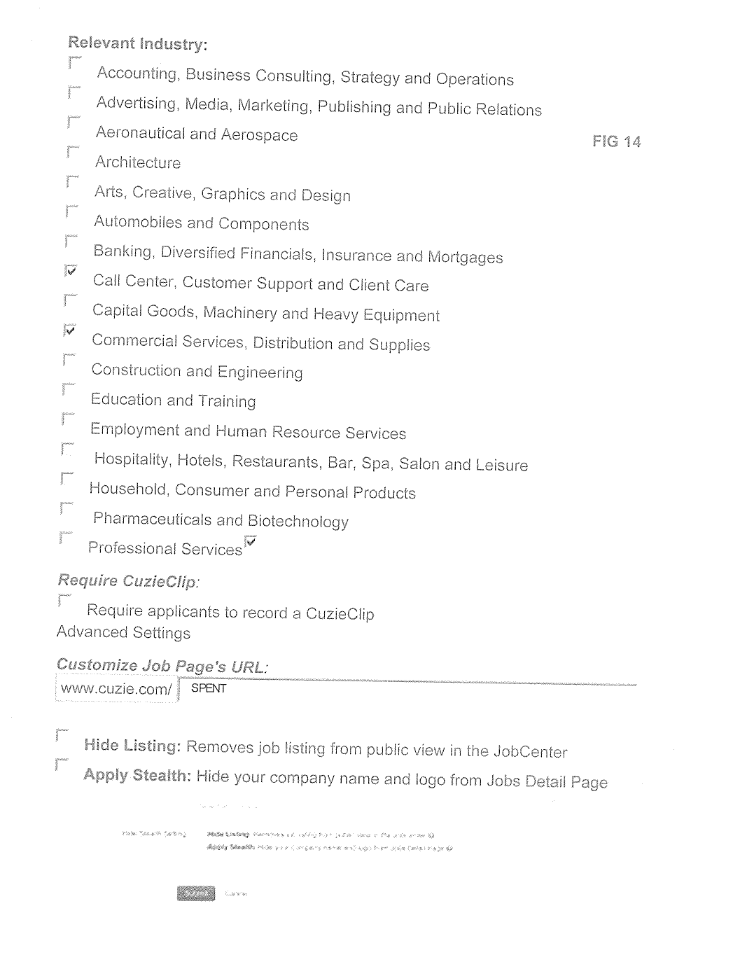

If the user selects START A CANDIDATE SEARCH, the processor causes the web page shown in FIGS. 13 and 14 to be generated and displayed. These web pages allow a business to describe a new job being offered and when this web page with the information that will described completed, the web site processor uses the information from the web pages of FIGS. 13 and 14 to create a job details web page that describes the job. The processor stores the job details web page in the memory.

Referring to FIG. 13, the user first provides a job description and job requirements. The web page first asks the user to enter a JOB LISTING HEADLINE. Then the web page asks the user to enter a JOB TITLE. Next, the user enters a DESCRIPTION. The description can be somewhat lengthy. Next the user enters job details, including a CAREER ROLE, a DESCRIPTION OF SKILLS AND SPECIALTIES, a MINIMUM SALARY, a JOB LOCATION ZIP CODE and TRAVEL REQUIREMENTS. The user can enter additional requirements as well. For example, as shown in FIG. 13, the user can also specify a MINIMUM YEARS OF EXPERIENCE, a MINIMUM EDUCATIONAL LEVEL, CAREER TYPES (full time, part time, contract, internship or temporary). As shown in FIG. 14, the user can also select a RELEVANT INDUSTRY from a list of industries. The user can also customize the URL of the Job Details Web Page, in a manner similar to the way the URL of the job center web page is customized. This field for the customized URL is automatically completed by the web site processor, but the user can enter a URL that identifies the business offering the job. For example, if ABC Corp were looking for a patent attorney, then the user could enter ABC-Patent Attorney as the URL. In this case, when the job details web page created for this job is displayed to a third party, the web site processor creates the URL as a combination of the web site URL and the created URL. Thus, if cuzie were running the employment web site, then the URL associated with the job details web page created for this job would be www.cuzie.com/ABCCorp-patentattorney.

At the bottom of the web page of FIG. 14, the user is asked to create two stealth mode parameters. Under the title HIDE SEARCH SETTING, the user is first asked whether he or she wants to HIDE LISTING—REMOVE JOB LISTING FROM PUBLIC VIEW IN THE JOBCENTER. If the user checks this box, the web site processor does not list the related job on the job center web page when that web page is sent to a third party (not the business) for display. Thus, the job is offered in “stealth mode” because it will not be displayed on a business' job center web page. The user is also asked whether he or she wants to APPLY STEALTH—HIDE YOUR COMPANY NAME AND LOGO FROM JOB DETAILS WEB PAGE. If this user checks this box, the web site processor does not show the business' name or logo or any other description of the business on the job details web page when a third party (not the business) views the job details web page. Once the web page of FIGS. 13 and 14 is submitted to the employment server of the present invention, the processor stores these two stealth parameters in memory as described in FIG. 4.

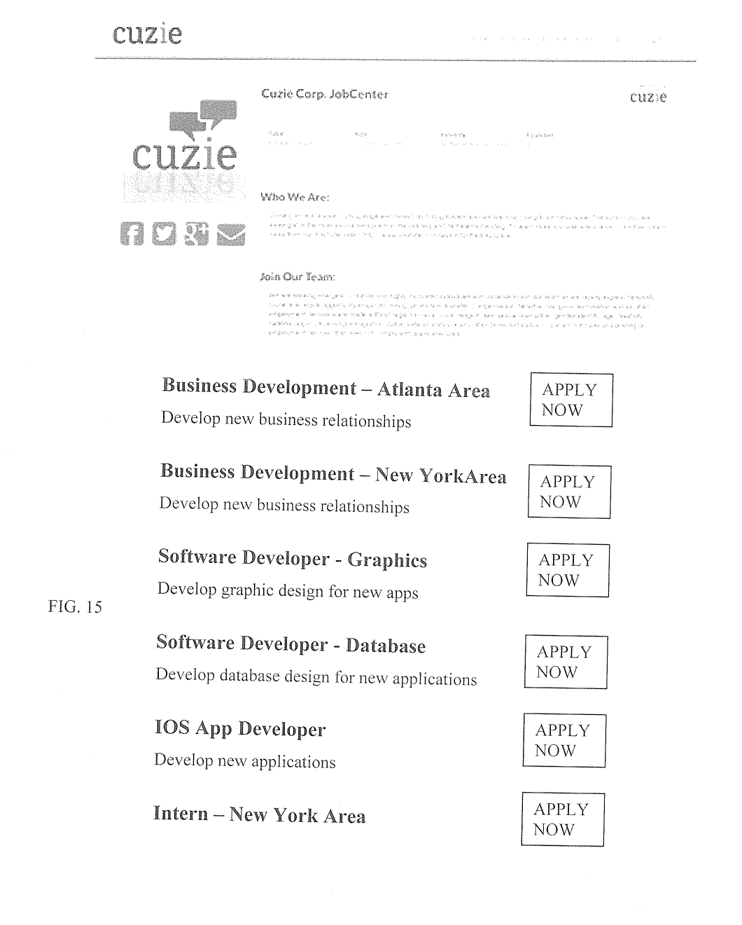

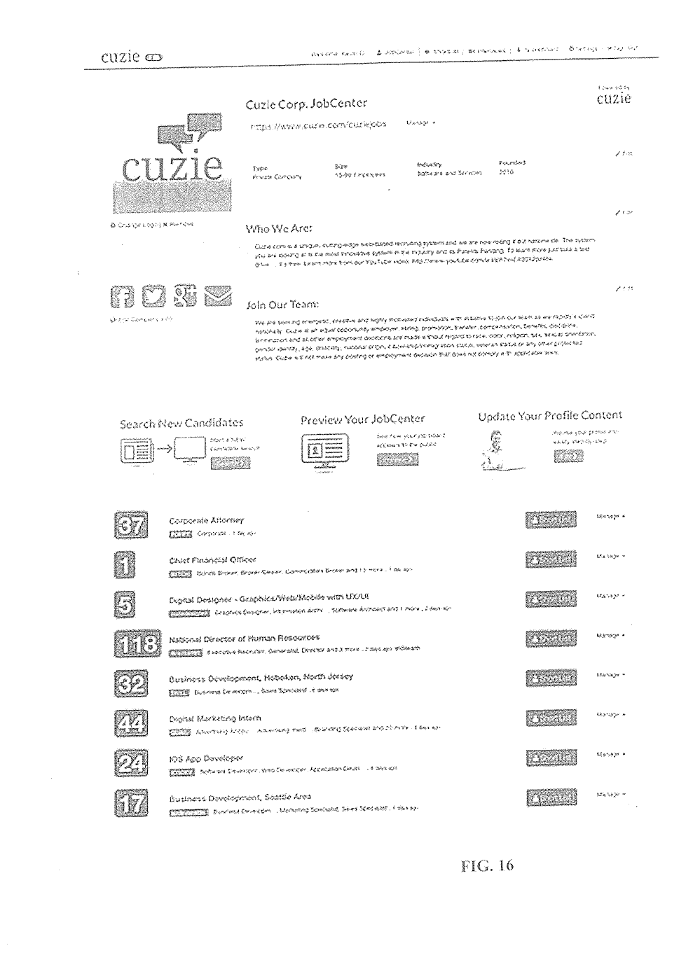

FIGS. 15 and 16 illustrate a public view of a job center web page having a plurality of job postings listed. This is the view a third party would see if it requested a business' job center web page. All of the job center web pages are searchable over the internet. Thus, a search of a business may reveal the business' job center web page and the employment server of the present invention would send the job center web page to the third party for display on the third party's web access device upon request by the third party.

When any job center web page is displayed, the processor searches the Job Center and the Job Details tables to determine which jobs the business has available. The processor then constructs the job center web page so that it lists information about every job, including the title and a description of each job, as shown in FIGS. 15 and 16.

If a job candidate wants to apply for any job, then he or she can simply click on the APPLY NOW button to the right of the job listing and an application is made for the job to the business owning the job center web page.

However, in accordance with aspects of the present invention, not all jobs that the business is offering are necessarily listed on the job center web page. Before the web site processor creates the job center web page for viewing by a third party, it first checks the stealth mode parameter in the Job Details table of FIG. 4 for each job associated with the business (and therefore with the job center web page. If the stealth mode parameter is set for a particular job, then in accordance with one aspect of the present invention, the web site processor does not include the job in the job listing on the job center web page when the processor sends the job center web page to a third party for display. However, if the stealth mode parameter for a job is not set, then the web site processor causes the job to be listed in the job center web page when it is displayed to a third party.

This feature is helpful if a business is advertising a job but does not want it known that they are seeking a job candidate to fulfill that role. This may be the case if a business is moving in a new direction and does not want to advertise that fact at the moment. There may be other circumstances when a business may not want to advertise that it is seeking a new employee is a certain role. The employment web site of the present invention provides the plurality of businesses with the capability to set the stealth mode parameter at any time as the business concerns change.

When the job center web page is viewed by the registered user of the business, the web site processor does not need to check the stealth mode parameter because it displays all jobs on the job center web page to the business. The processor can determine this in a number of different ways. For example, if the third party seeking the job center web page is logged in to the system as a registered user for the business, then the processor does not check the stealth mode parameter before displaying the job center web page and, in this case, includes all jobs on the job center web page.

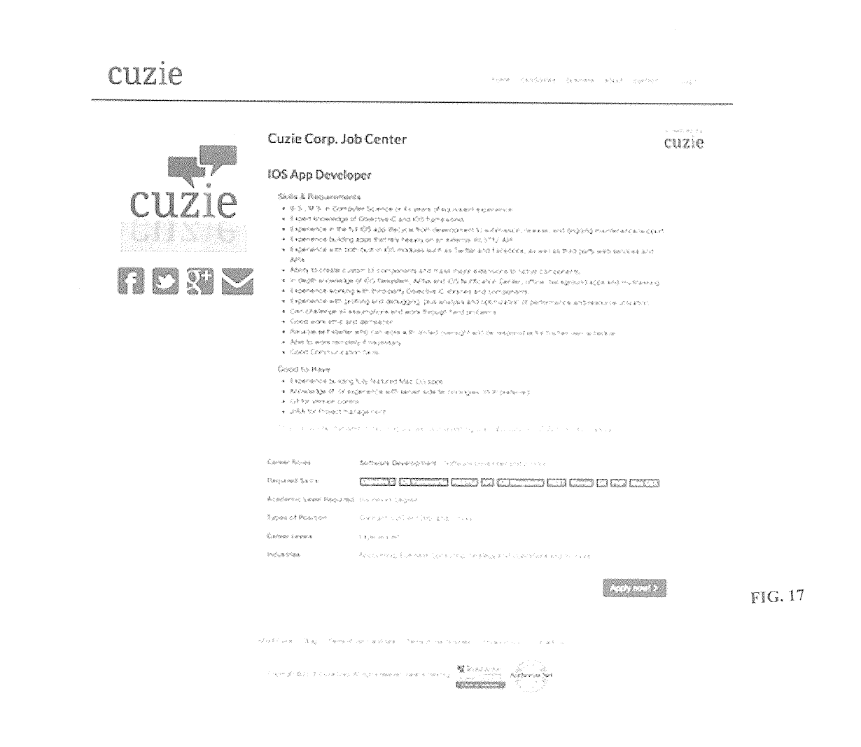

FIG. 17 illustrates a job details web page. This web page can be accessed by a third party, such as a job candidate, in several ways. First, if the job candidate has accessed a business' job center web page, clicking on any of the job listings in the job center web page will cause the web site processor to send the associated job details web page to the job candidate for display on job candidate's web access device.

The job details web page of FIG. 17 includes information about the business that was entered by the business. For example it includes a business name and a business logo. It also includes a job title and a description of the job. The URL of the job details web page also includes the URL specified by the business which may help identify the business. For example, the URL of the job details web page of FIG. 17 may be www.xyz.com/cuzie-iosdeveloper.

However, in accordance with an aspect of the present invention, this information is not always displayed on the job details web page or in association with the job details web page. Before this information is displayed, the web site processor checks the stealth mode parameter associated with each job. Recall, this parameter was set when the business created the job opportunity. The web site processor provides businesses with the capability of setting this parameter, or changing the parameter, at any time. Before displaying any job details web page, the web site processor checks the stealth mode parameter in memory (see FIG. 4) to see if it is set. If it is set, then the web site processor, in accordance with an aspect of the present invention, removes the name and logo from the job details web page before sending it to a job candidate for display on the job candidate's web access device. In accordance with a further aspect of the present invention, the web site processor also removes any URL entered by the business when the job details web page was created, although there should be none if the job was created with the stealth mode parameter set. Then the job details web page is displayed without the business name and logo, or any other reference to the business that created the job.

However, if the job details web page is displayed by the business, the web site parameter does not remove the references to the business. Again, this feature is useful under certain circumstances when the business does not desire that it be known that they have a certain job available.

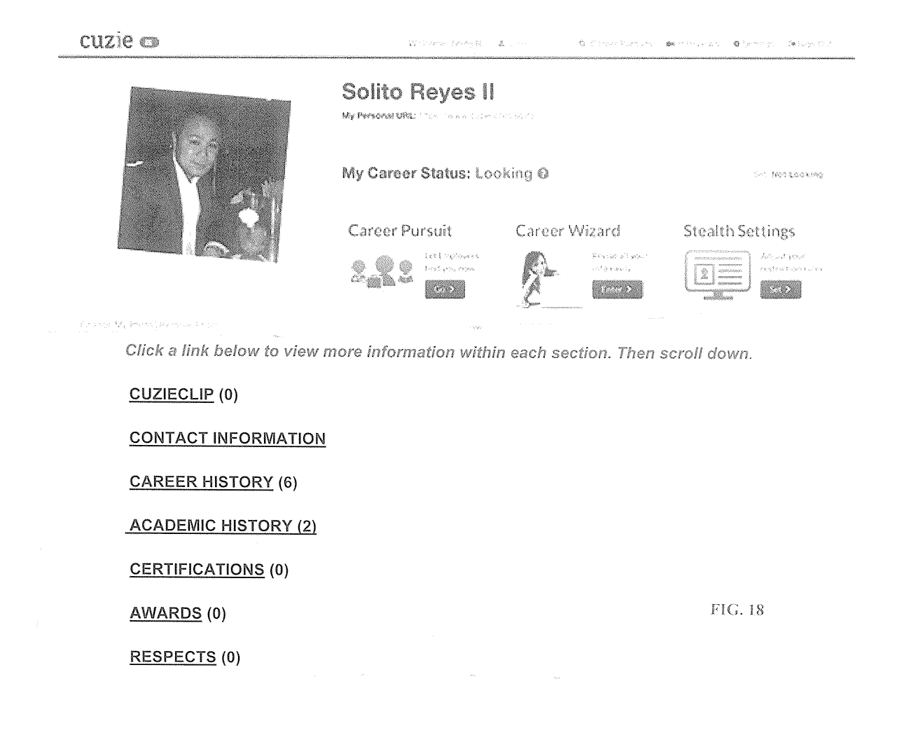

FIG. 18 illustrates a job candidate web page. It includes information entered by the job candidate while accessing the employment web site of the present invention. For example, the job candidate's name and picture are shown. Below, a video clip of the job candidate (called a CUZIECLIP), contact information, a career history, an academic history, certifications, awards and respects by third parties can be viewed by anyone accessing the job candidate web page.

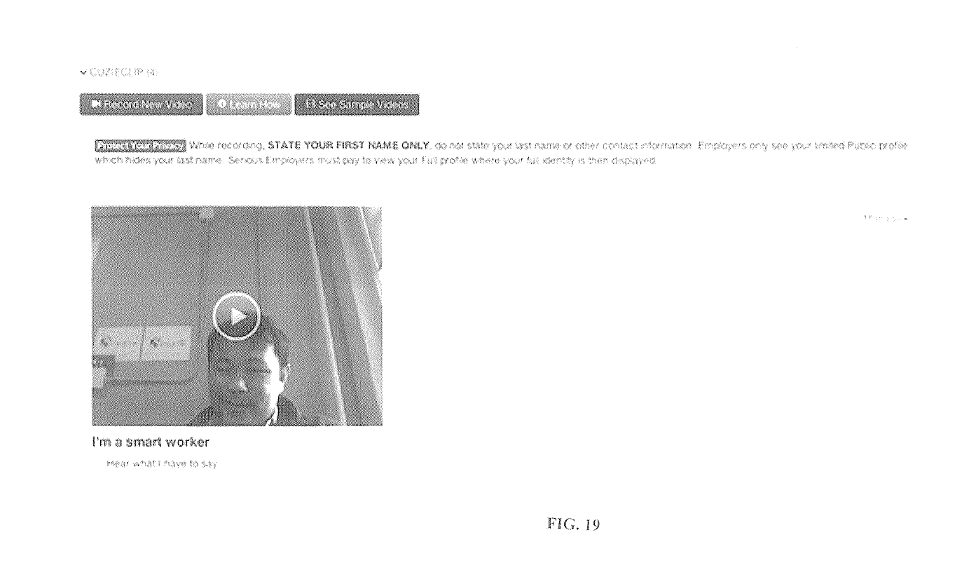

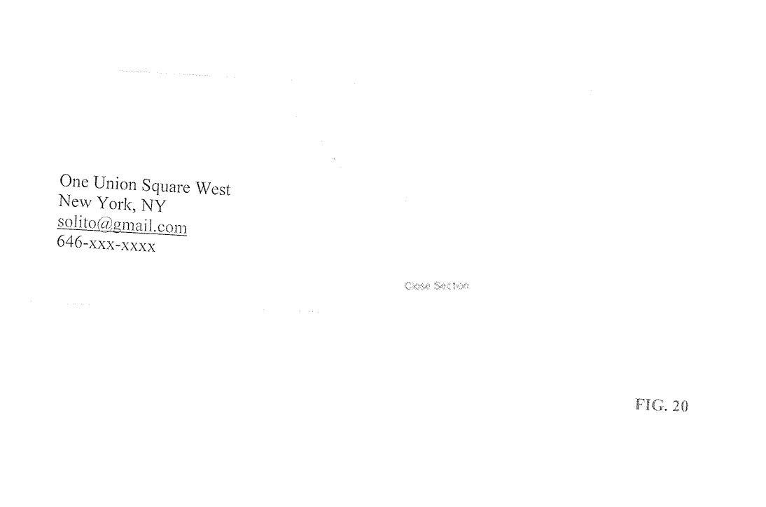

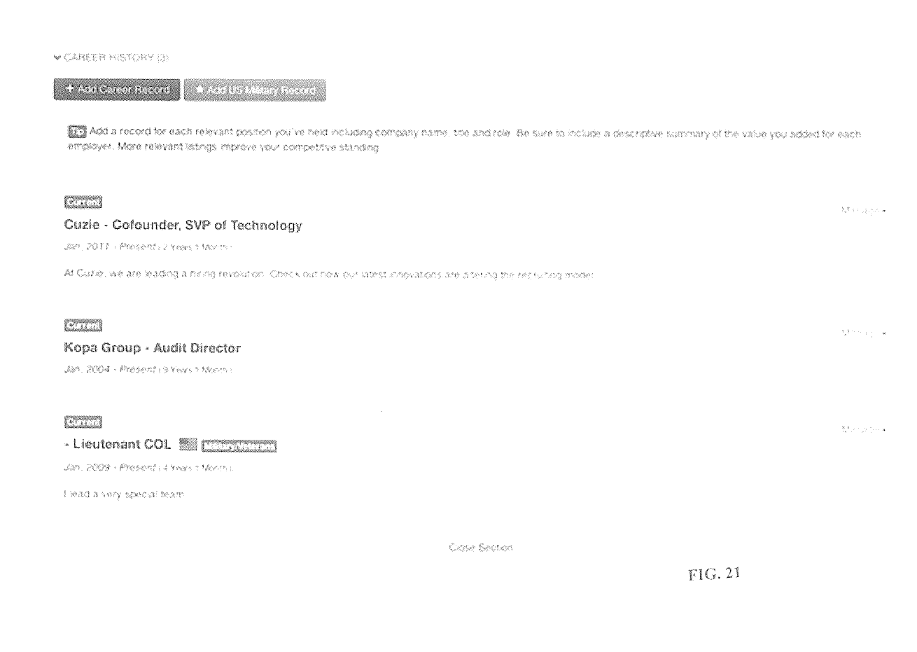

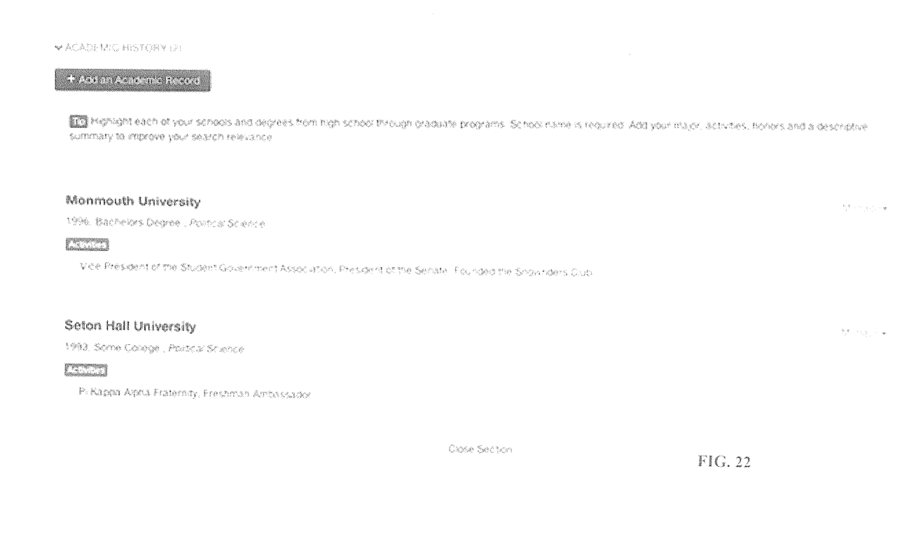

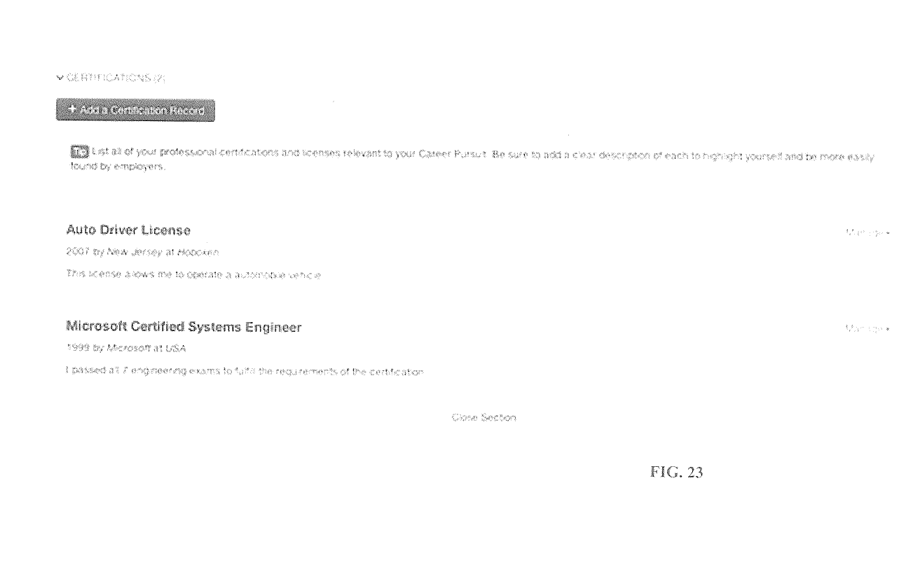

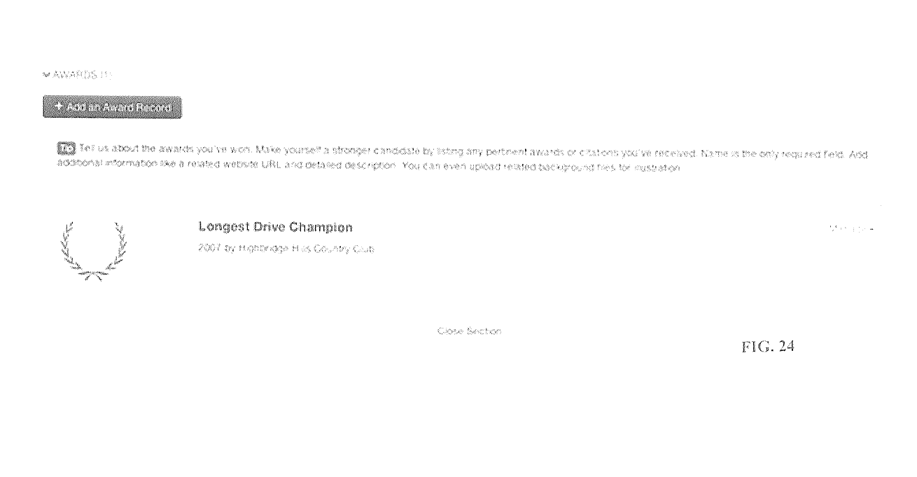

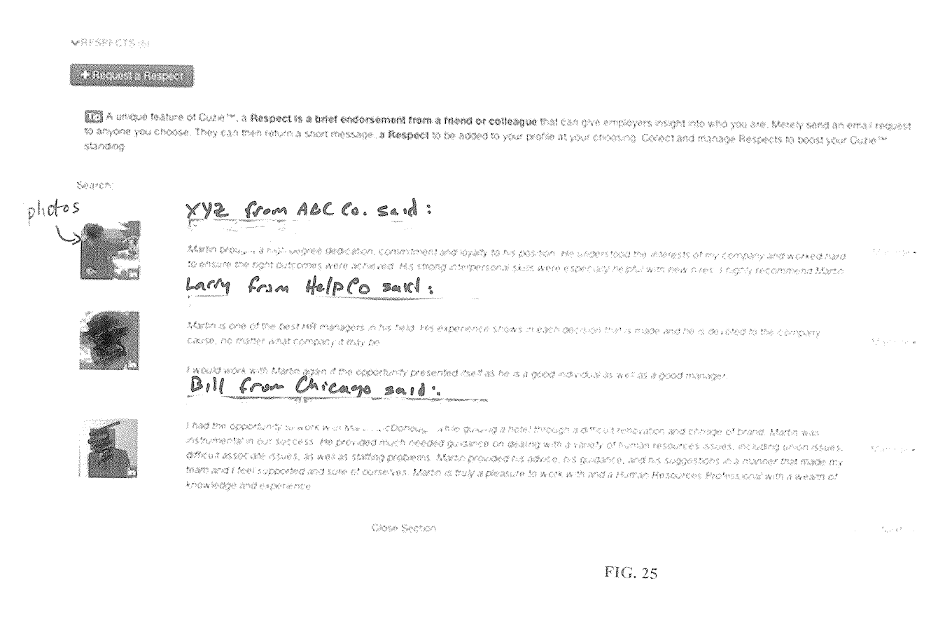

This information is shown in detail in the web pages shown in FIGS. 19 to 25. FIG. 19 shows the video clip, accessible from the web page of FIG. 18 by clicking the CUZICLIP tab. FIG. 20 shows the contact information, accessible from the web page of FIG. 18 by clicking the CONTACT INFORMATION tab. FIG. 21 shows the career history, accessible from the web page of FIG. 18 by clicking the CAREER HISTORY tab. FIG. 22 shows the academic history, accessible from the web page of FIG. 18 by clicking the ACADEMIC HISTORY tab. FIG. 23 shows the certifications of the job candidate, accessible from the web page of FIG. 18 by clicking the CERTIFICATIONS tab. FIG. 24 shows the awards the job candidate has received, accessible from the web page of FIG. 18 by clicking the AWARDS tab. FIG. 251 shows the respects the job candidate has received, accessible from the web page of FIG. 18 by clicking the RESPECTS tab.

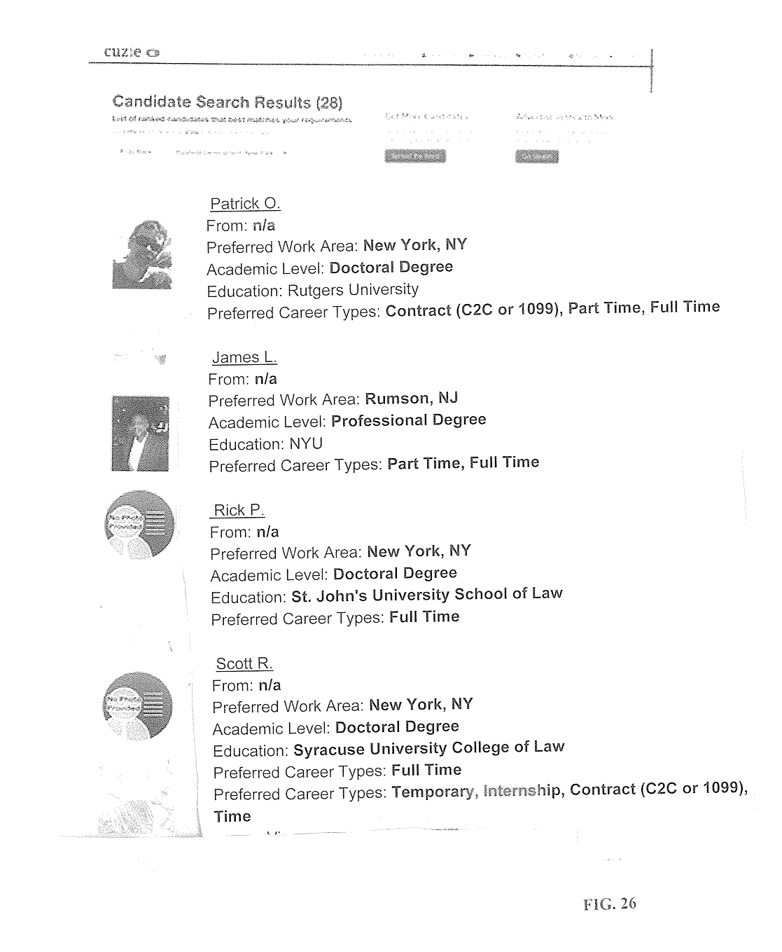

FIG. 26 shows a candidate search result web page. This web page is accessible by a business' administrator. It can be accessed by clicking on any job listed on a job center web page. As shown, a summary of each job candidate is shown. The summary includes a picture and a first name and possibly a last name initial. The summary also indicates where the job candidate is from, where the job candidate prefers to work, the academic level of the job candidate, the education institute that the job candidate attended, and the preferred career type (full time, part time, contract, etc).

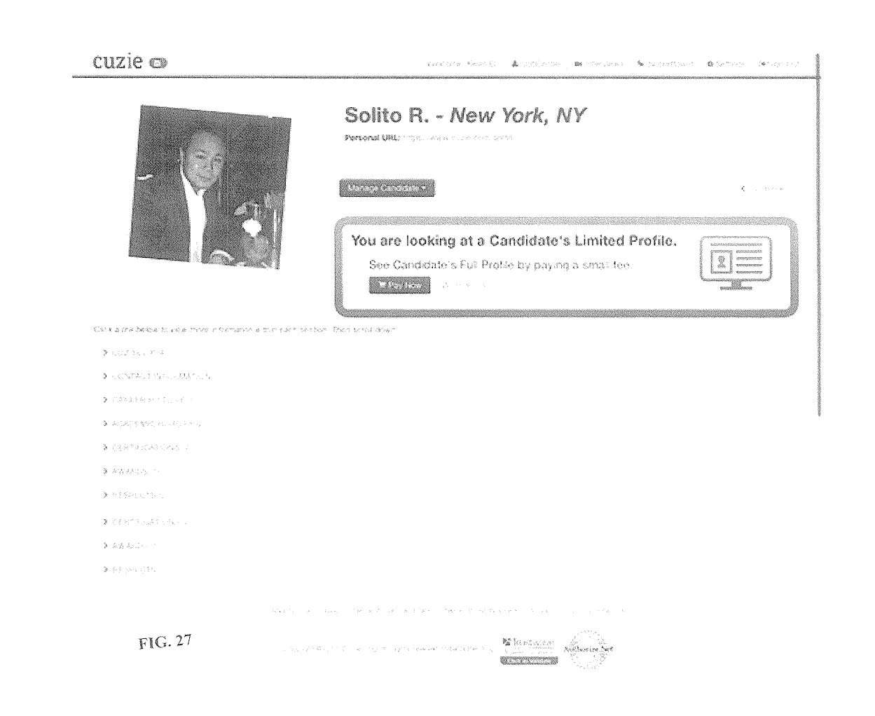

Clicking on any one of the summaries of the individual job listed in FIG. 26 causes the web site processor to display the web page of FIG. 27 to the business user. This is a limited access web that only shows a limited summary of the job candidate's qualifications. Importantly, the web site processor includes the number of video clips, the number of jobs listed in the career history, the number of institutions listed in the academic history, the number of certifications the job candidate has, the number of awards the job candidate has, and the number of respects the job candidate has. The processor indicates these as numbers in parenthesis next to the tab. For example, in FIG. 27, the entry CUZIECLIP(4) indicates there are four videos associated with the job candidate.

Based on this information, if the business is interested in learning more, the business can pay a small fee and have access to all of this information. In this case, the processor will cause web pages similar to those shown in FIGS. 19 to 25 to be displayed to the business user.

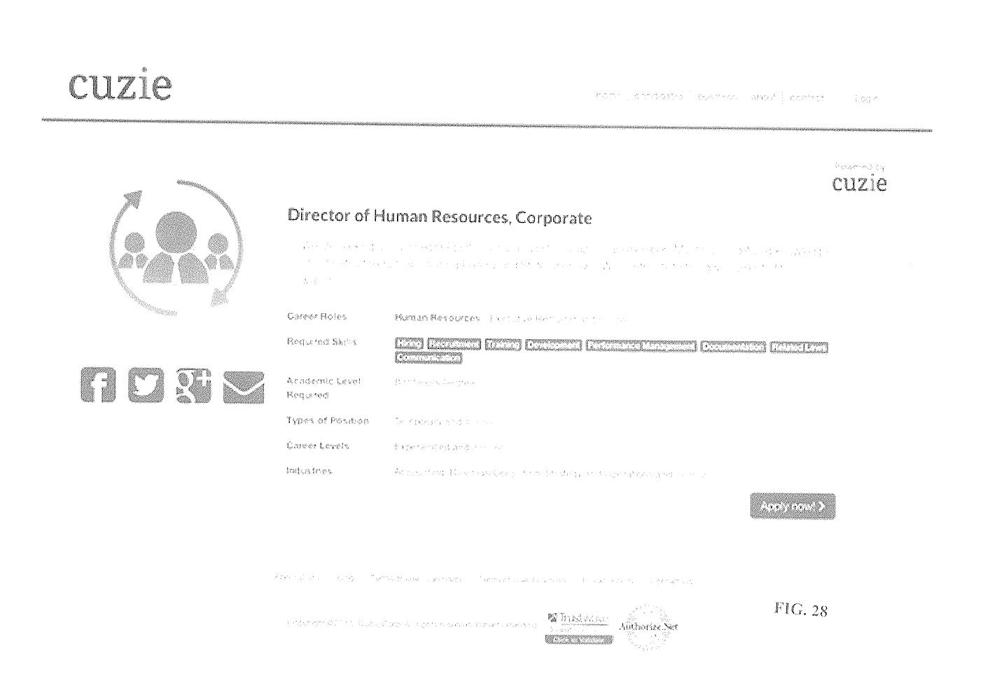

FIG. 28 illustrates a job details web page displayed to a third party, such as a job candidate, in stealth mode. This was previously described. Note that the business name and the business logo has been removed. The reference to CUZIE in the top corners indicates the company providing the employment web site, not the company offering the job.

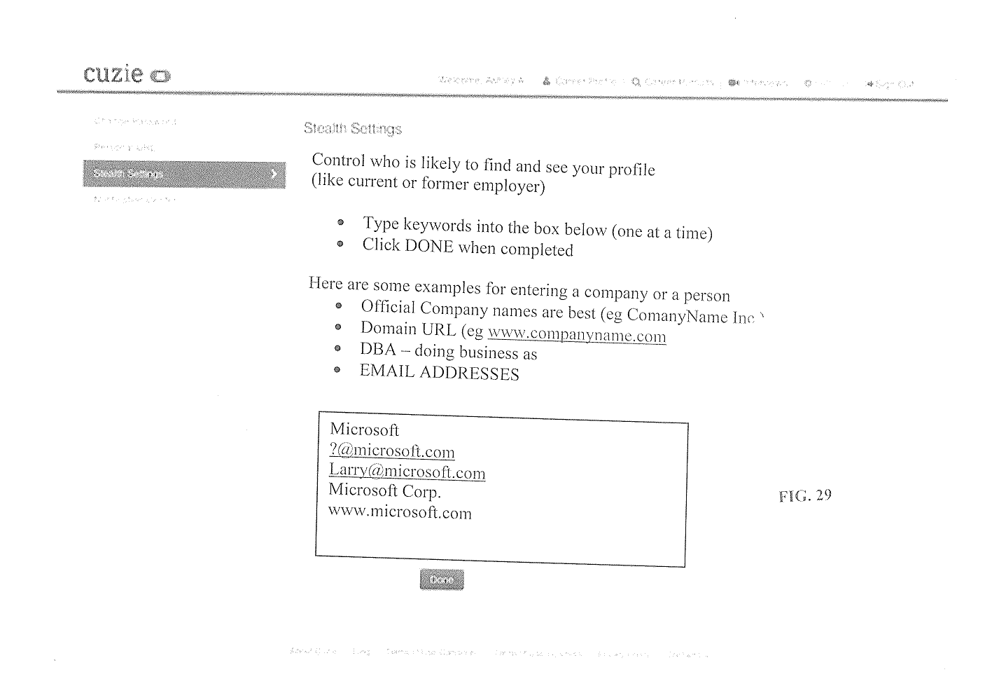

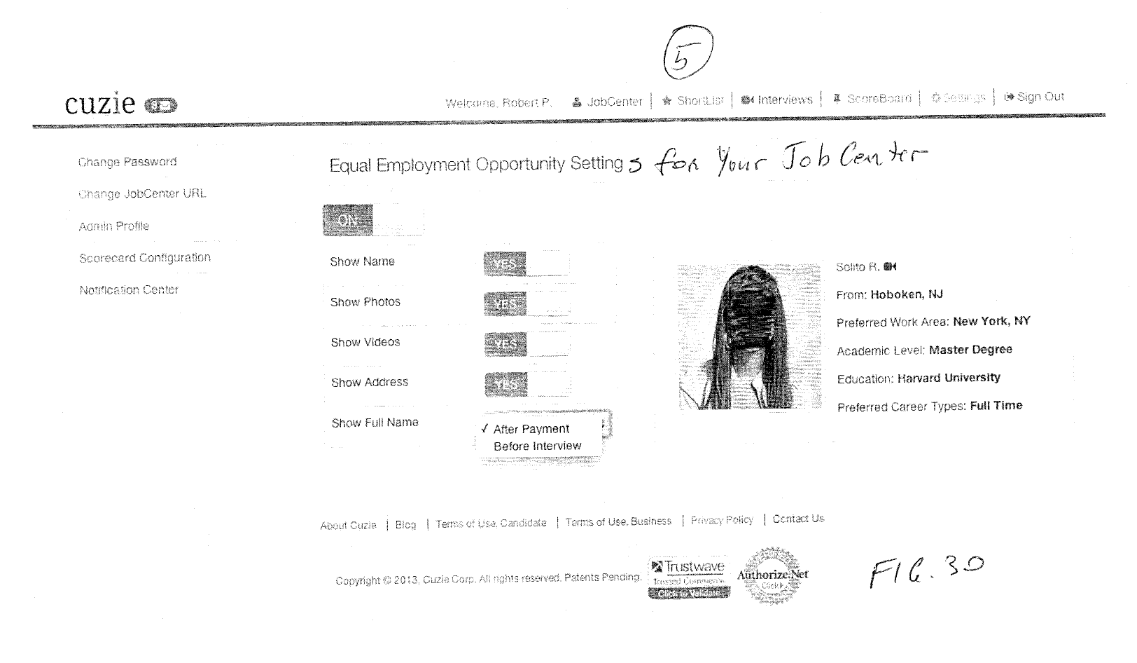

FIG. 29 shows a web page that is shown to a job candidate during the creation of a job candidate web page, in accordance with an aspect of the present invention. Keywords are typed into the text box at the bottom of the web page. In accordance with an aspect of the present invention, if a request to view a job candidate's web page is made, the web site processor checks the web information provided by the requestor. If the keyword's provided by the job candidate are found in the web access information, then the job candidate's web page is not displayed.

Referring to FIG. 16 again, a job center web page accessible by the business that created it is illustrated. In accordance with an aspect of the present invention, the web site processor allows a job candidate to express interest in a job or to apply for a job. For example, a job candidate may find a job details page by an Internet search or when viewing a business' job center web page. As explained before, the job candidate can apply for the job by clicking on an APPLY NOW button on either the job center web page or on the job details web page. When the job candidate does so, the web site processor stores the application, including the job's and the job candidate's identities in memory, as shown in FIG. 4. When the business views its job center web page, in accordance with an aspect of the present invention, the web site processor lists each job as explained before. But the web site processor also accesses the memory to determine how many job candidates have applied for the job. In accordance with this aspect of the invention, the web site processor causes the number of applicants to be displayed next to the job listing. Referring to FIG. 16, one can see that there are 37 applicants for the CORPORATE ATTORNEY job.

This invention can use any of the concepts disclosed in co-pending U.S. patent application Ser. No. 13/628,830, filed on Sep. 27, 2012, which is hereby incorporated by reference.

Thus, the present invention provides systems and methods for providing employment information between job candidates and businesses. In accordance with an aspect of the present invention, a method of providing employment information via a server in communication over an Internet with a plurality of job candidates and with a plurality of businesses, is provided. In accordance with one aspect of the method, the processor creates a job candidate web page containing a set of job qualification information and stores the job candidate web page in the memory as being related to the one of the plurality of job candidates. The processor also creates a job center web page containing information describing one of the plurality its business and stores the job center web page in the memory as being related to the one of the plurality of businesses. The processor also creates a job details web page that includes information describing a job and that is associated with one of the job center web pages and stores the job details web page and its association with one of the job center web pages in the memory.

As mentioned before, the processor creates a plurality of job candidate web pages, a plurality of job center web pages and a plurality of job details web pages are created by the processor and stored in memory and each of the web pages is searchable by a third party over the interface to the Internet and wherein each of the web pages can be displayed on an Internet access device used by the third party.

The plurality of job candidates can apply for a job related to one of the job details web page while accessing the server, and when one of the plurality of job candidates applies for the job, the processor stores an identity of the job candidate and the identity of the job in the memory, and when a business that created the job details web page views its job center web page, the processor determines how many job candidates have applied for each job and causes the job center web page to display a list of associated jobs and a number of job candidates that have applied for each job on the list of associated jobs.

In accordance with another aspect of the present invention, when the job center web page is displayed on a third party's web access device, the processor determines the URL of the displayed job center web page as a combination of a URL of the employment server and of the business URL name.

In accordance with another aspect of the present invention, the processor determines that a third party is requesting a job details web page to be displayed. Then the processor checks a stealth mode parameter in the memory associated with the job details web page to be displayed. If the stealth mode parameter is checked, then the processor modifies the job details web page to be displayed according to the stealth mode parameter by removing information relating to the one of the plurality of businesses that created the job details web page, including at least the name of the one of the plurality of business that created the job details web page. Then the processor or the web site causes the modified job details web page to be displayed.

The web site and the web site processor can also cause the job center web page to be displayed in stealth mode as well. In accordance with this aspect of the present invention, the processor determines that a third party is requesting a job center web page to be displayed, the processor checks a stealth mode parameter in the memory associated with the job center web page to be displayed; and the processor modifies the job center web page to be displayed according to the stealth mode parameter by removing information relating to the one of the plurality of businesses that created the job center web page, including at least the name of the one of the plurality of business that created the job center web page. Then the processor causes a modified job details web page to be displayed to the third party.

One of the results of using the tools of the present invention is that job candidates can seek the job they desire anywhere in the world. Likewise, a business can seek the job candidate they want anywhere in the world. Further, the present invention greatly reduces the expenses associated with finding the right job candidate or the right person to work for.

Thus, in summary, the processor stores job center web pages, job detail web pages and job candidate web pages in the memory. When a business requests its job center web page, the processor accesses the job center web page in memory and causes it to be displayed to the business over the Internet. The display of the job center web page includes business identifier information (such as name, logo, description and URL identifier) and a list of the plurality of jobs offered by the business and, next to each one of the plurality of jobs in the list, the number of job candidates that applied for each of the plurality of jobs.

As part of this process, if the processor determines that a third party who is not the business sent the request, the processor causes the job center web page to be displayed to the third party. The display of the job center web page includes the business identifier information and the list of the plurality of jobs offered by the business, however, the display of the job center web page does not include the number of qualified job candidates for each of the plurality of jobs. In accordance with a further aspect of the present invention, the processor also checks a stealth mode parameter and, if the stealth mode parameter is set, the processor causes the business identifier information (for example, name, logo, description and unique business URL identifier) not to be included on the job center web page.

Thus, the processor processes the job center web page based upon who made the request for the web page (business or third party) and based on the setting of the stealth mode parameter. The processor modifies the job center web page based on the setting of the stealth mode parameter. The processor similarly processes requests for job details web pages.

When a business requests a job details web page that it created and that is associated with the business' job center web page, the processor accesses the job details web page in memory and causes it to be displayed to the business over the Internet. The display of the job details web page includes business identifier information (such as name, logo, description and URL identifier) and a description of the job. As part of this process, if the processor determines that a third party who is not the business sent the request, the processor checks a second stealth mode parameter. If that second stealth mode parameter is set, the processor causes the job details web page to be displayed to the third party with all of the business identifier information removed from the job details web page, including the URL of the job details web page. Thus, the name, logo and description of the business, as well as the entered URL identifier, are removed for the job details web page in accordance with the setting of a second stealth mode parameter.

As described in the earlier filed U.S. patent application Ser. No. 13/628,830, filed on Sep. 27, 2012, the employment web site and server also matches job candidates to jobs being offered by businesses. In other words, the processor, accessing job candidate qualification information, determines which of the job candidates having qualification information stored in the memory, are qualified for which of the available jobs. Job candidates are matched to jobs by the processor by considering job qualifications and the job description entered by the business according to any of a number of matching processes. One suitable matching and qualifying process is described in U.S. patent application Ser. No. 13/628,830 at paragraphs 0212 to 0249 and in FIGS. 35 to 48. These sections and portions of U.S. patent application Ser. No. 13/628,830 are specifically incorporated herein by reference. Other matching processes, including simpler matching processes, however, can be used herein. The specific matching process is not important. The essence of the matching or qualification process is that a score is determined for each job candidate to each job, and if the score is exceeded, then the job candidate is deemed qualified or matched. The highest scoring job candidates (e.g. ten top 5% or the top 10, 20 or 50 candidates) or job candidates exceeding a score, can be considered matched or qualified.

The employment web site and server matches or qualifies job candidates to jobs on an ongoing basis. For example, the matching process can be run in the background on a periodic basis. Alternatively, the matching process can be run on an as needed basis.

In accordance with an aspect of the present invention, the processor compares the description of a job to each job candidate's job qualifications and determines which job candidates are qualified for the job, and generates a score that indicates how qualified a job candidate is for the job. The processor deems those scoring above a certain number are deemed qualified for the job. This process is repeated for each job.

As previously described, when the web page shown in FIG. 26 is shown to a business, the processor lists the job candidates for the job being viewed. This is the job candidate search results web page, shown when a business selects a job listed on the job center web page, for example, by clicking on the number next to the job listing shown in FIG. 16. In accordance with aspects of the present invention, only those job candidates that the processor deems qualified after the comparison and scoring previously described, are listed on the web page shown in FIG. 26. In accordance with another aspect of the present invention, the job candidates are listed in FIG. 26 in the order of their score, with the highest scoring job candidates listed first.

In accordance with another aspect of the present invention, the numbers next to the jobs listed in the job center web page of FIG. 16 indicates the number of job candidates that qualify, according to the processor, for the job. Each time the job center web page of FIG. 16 is displayed to a business, the processor accesses the memory to compare the job requirements listed in the job description to the qualifications of the job candidates and determines how many job candidates qualify for each job listed on the job center web page.

In accordance with an aspect of the present invention, job candidates enter information about themselves on web pages and send the information to the server for processing by the processor and storage in the memory. The information entered by each job candidate includes a name, a photo, a video, and an address. Other information can also be entered, such as an academic record, an employment record, awards, certifications, respects and the like. All of the information shown in FIGS. 18-25 can be entered by the job candidate. The form of the web page on which the entry is made is not important. However, once each of the job candidates enter this information, it is sent to the server and stored in memory in association with the job candidate by the processor for later use by the processor.

The process of creating a job center and a job center web page have been previously discussed. Exemplary web pages used to create a job center are shown in FIGS. 7-10. An exemplary job center web page is shown in FIGS. 15 and 16. The process of creating a job and a job details has also been discussed.

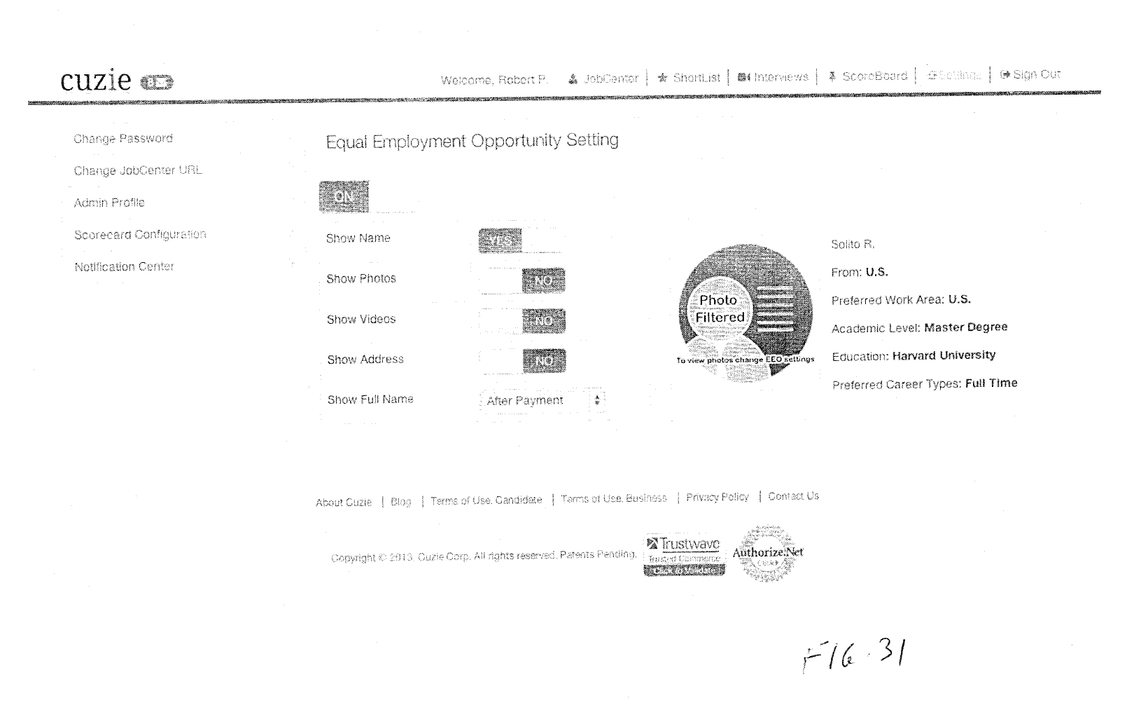

In accordance with an aspect of the present invention, a further step is used to create a job center and a job center web page. FIG. 30 illustrates a web page that is provided to a business user in accordance to create a job center web page in accordance with an aspect of the present invention. The web page of FIG. 30 is a fifth web page that is presented to a business during the creation of a job center, after FIGS. 7-10. A series of slider buttons are provided on FIG. 30. A first slider is provided under the label EQUAL EMPLOYMENT OPPORTUNITY SETTING to turn on and to turn off the controls that implement the Equal Employment controls.

A slider is provided next to a SHOW NAME label. A slider is provided next to a SHOW PHOTOS label. A slider is provided next to a SHOW VIDEOS label. A slider is provided next to a SHOW ADDRESS label. A drop down list box is provided next to a SHOW FULL NAME label.

When this web page is sent to the server, the processor determines the settings of these sliders and stores the settings in memory. If the SHOW NAME slider is set to YES, the processor sets the parameter Show Name in memory to Yes. If the SHOW NAME slider is set to NO, the processor sets the parameter Show Name in memory to No.

If the SHOW PHOTO slider is set to YES, the processor sets the parameter Show Photo in memory to Yes. If the SHOW PHOTO slider is set to NO, the processor sets the parameter Show Photo in memory to No.

If the SHOW VIDEOS slider is set to YES, the processor sets the parameter Show Video in memory to Yes. If the SHOW VIDEOS slider is set to NO, the processor sets the parameter Show Video in memory to No.

If the SHOW ADDRESS slider is set to YES, the processor sets the parameter Show Address in memory to Yes. If the SHOW ADDRESS slider is set to NO, the processor sets the parameter Show Address in memory to No.

The drop down list box contains two entries. One is After Payment. The other is Before Interview.

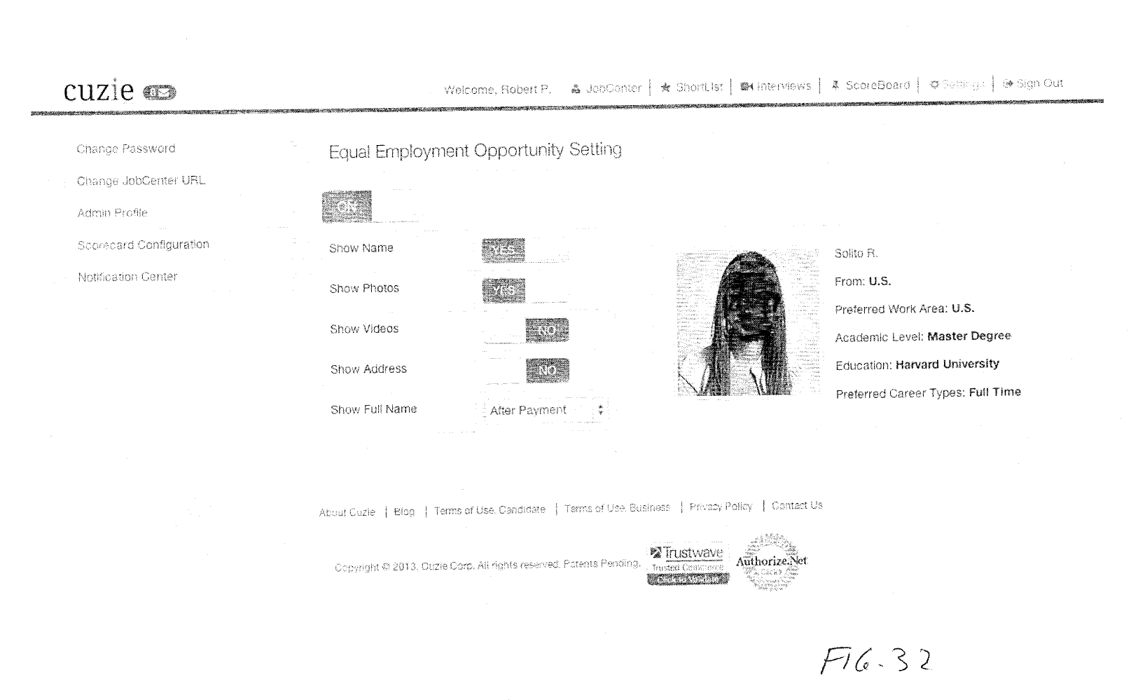

The area to the right of the sliders and drop down list box shows what information is displayed and will be displayed on other web pages, such as a candidate search result web page. If the EQUAL EMPLOYMENT OPPORTUNITY SETTING slider is set to yes, then the name, photos, videos and address of the job candidate is available as shown in FIG. 30. If this slider is set to no, then initials or another identifier is shown for a job candidate's name, no photos of a job candidate can be initially viewed, no videos of a job candidate can be initially viewed and the address of the job candidate is set to none or to the country the job candidate resides in. Various configurations that result from various settings of the sliders are shown in FIGS. 31 and 32.

In accordance with an aspect of the present invention, any of the sliders can be used individually or in any combination.

When the a business requests a job candidate search result web page, the processor accesses the memory to construct the contents of the job candidate search result web page in accordance with the previously described parameters that have been stored in memory. So, for example, when a business is looking at its job center web page of FIG. 16, a list of jobs populates the web page. When the user clicks on one of the jobs listed, a job details web page having a description of the job, such as the one shown in FIG. 17 is displayed by the processor to the business. When the user clicks on the number next to one of the listed jobs, the processor causes a candidate search results web page, such as the one shown in FIG. 26, to be shown to the business user. The candidate search results web page can show the job candidates who have applied for the job. It can also show the job candidates who the processor has determine are qualified for the job. Recall the processor makes this determination by accessing memory to compare the job qualification information entered by a job candidate to the job information entered by a business. The processor performs this qualification for each job candidate and for each job. Alternatively, all job candidates who have applied and all qualified job candidates can be included on the list of job candidates shown on the job candidates search results web page.

Referring to FIG. 26, information related to a job candidate is shown next to each job candidate. The information includes the job candidate's name, address, preferred work area, academic information, educational institute and preferred career type. In accordance with aspects of the present invention, the processor upon receiving a request for a job candidate search results web page, determines the status of the equal opportunity controls described with respect to FIG. 30 and constructs the job candidate search results web page accordingly, setting the information for each job candidate in accordance with the status of the equal opportunity controls.

If the SHOW NAME parameter associated with the business job center is set to yes, the processor causes the job candidate's name to be shown on the job candidates search results web page. If it is set to no, then the processor causes the name not to be shown on the web page. Alternatively, the processor can cause initials of the job candidate or some other identifier to be shown on the web page.

If the SHOW PHOTO parameter associated with the business job center is set to yes, the processor causes the job candidate's photo is shown on the job candidates search results web page. If it is set to no, then the processor causes the photo not to be shown on the web page, such as in FIG. 31.

If the SHOW VIDEO parameter associated with the business job center is set to yes, the processor causes the job candidate's video to be available. Thus, if the business clicks on the job candidate's listing to access the job candidate web page, if the job candidate recorded a video, the processor will make the video available to the business, on a job candidate web page or on any other web page. If this parameter is set to no, then the processor causes the video (if there is one) not to be shown on any web page presented to the business, including a job candidate web page.

If the SHOW ADDRESS parameter associated with the business job center is set to yes, the processor causes the job candidate's address to be shown on the job candidates search results web page. If it is set to no, then the processor causes the address not to be shown on the web page. If it is set to no, then a more general address, such as the country of residence can be shown too.

In accordance with a further aspect of the present invention, if the business tries to view the job candidate web page, the processor constructs the job candidate web pages in accordance with the settings just described. Thus, the job candidate's name, photos, videos and address would or would not be available to the business, depending on the equal opportunity settings and the related parameters stored in memory.

Eventually, however, a business user will want to see this information concerning the job candidates they are interested in. The SHOW FULL NAME list drop box and the associated parameter stored in memory controls when the business user can see all of the information related to job candidates. If AFTER PAYMENT is selected in the drop down list box during the formation of a job center and stored in the memory, then a business cannot view the information in the manner set by the sliders until after one or more job candidates have been selected for further review and until after the business has paid for the right to conduct the further review. If BEFORE INTERVIEW is selected in the drop down list box during the formation of a job center and stored in memory, then a business cannot view the information in the manner set by the sliders until a job candidate has been selected for an interview. The payment or the selection for an interview can be accomplished in many different ways. Any of the methods disclosed in co-pending U.S. patent application Ser. No. 13/628,830, filed on Sep. 27, 2012, which is hereby incorporated by reference, can be used.

While there have been shown, described and pointed out fundamental novel features of the invention as applied to preferred embodiments thereof, it will be understood that various omissions and substitutions and changes in the form and details of the methods and systems illustrated and in its operation may be made by those skilled in the art without departing from the spirit of the invention. It is the intention, therefore, to be limited only as indicated by the claims.

We claim:

1. A method of providing an employment server having a memory that stores a set of qualifications for a plurality of job candidates and a plurality of jobs offered by a business and having a processor that generates a set of job candidates for each of the plurality of jobs, comprising
the processor receiving a request from the business for a job candidate search web page that lists the set of job candidates for one of the plurality of jobs and, for each job candidate in the set, displays a set of information about the job candidate;
the processor accessing a plurality of employment law controls previously selected by the business and forming the set of information for each job candidate in the set in accordance with the plurality of employment law controls; and
the processor causing the job candidate search results web page to be displayed to the business.

2. The method of claim 1, wherein one of the plurality of employment law controls is a name control that the processor uses to determine whether contents of the candidate search results web page that is shown to the business includes a name of any of the plurality of job candidates.

3. The method of claim 1, wherein one of the plurality of employment law controls is a photo control that the processor uses to determine whether contents of the candidate search report web page that is shown to the business includes a photo of any of the plurality of job candidates.

4. The method of claim 1, wherein one of the plurality of employment law controls is a video control that the processor uses to determine whether contents of the candidate search report web page that is shown to the business includes a video of any of the plurality of job candidates.

5. The method of claim 1, wherein one of the plurality of employment law controls is an address control that the processor uses to determine whether contents of the candidate search report web page that is shown to the business includes an address of any of the plurality of job candidates.

6. The method of claim 2, wherein one of the plurality of employment law controls is a time control that the processor uses to determine whether contents of the candidate search report web page that is shown to the business includes the name of any of the plurality of job candidates.

7. The method of claim 3, wherein one of the plurality of employment law controls is a time control that the processor uses to determine whether contents of the candidate search report web page that is shown to the business includes the photo of any of the plurality of job candidates.

8. The method of claim 4, wherein one of the plurality of employment law controls is a time control that the processor uses to determine whether contents of the candidate search report web page that is shown to the business includes the video of any of the plurality of job candidates.

9. The method of claim 5, wherein one of the plurality of employment law controls is a time control that the processor uses to determine whether contents of the candidate search report web page that is shown to the business includes the address of any of the plurality of job candidates.

10. The method of claim 1, wherein:
a first of the plurality of employment law controls is a name control that the processor uses to determine whether contents of the candidate search report web page that is shown to the business includes a name of any of the plurality of job candidates;
a second of the plurality of employment law controls is a photo control that the processor uses to determine whether contents of the candidate search report web page that is shown to the business includes a photo of any of the plurality of job candidates;
a third of the plurality of employment law controls is a video control that the processor uses to determine whether contents of the candidate search report web page that is shown to the business includes a video of any of the plurality of job candidates; and
a fourth of the plurality of employment law controls is an address control that the processor uses to determine whether contents of the candidate search report web page that is shown to the business includes an address of any of the plurality of job candidates.

11. The method of claim 10, wherein one of the plurality of employment law controls is a time control that the processor uses to determine whether contents of the candidate search report web page that is shown to the business includes the name, the photo, the video and the address of any of the plurality of job candidates.

12. The method of claim 11, wherein the time control can be set such that the processor causes the photo, the video and the address of any of the plurality of job candidates to be shown to a business only after job candidates are selected for an interview.

13. The method of claim 11, wherein the time control can be set such that the processor causes the photo, the video and the address of any of the plurality of job candidates to be shown to a business only after the business pays a fee to view one of the plurality of job candidates.

14. The method of claim 12, wherein the time control can be set such that the processor causes the photo, the video and the address of any of the plurality of job candidates to be shown to a business only after the business pays a fee to view one of the plurality of job candidates.

15. The method of claim 1, wherein the set of job candidates for each one of the plurality of jobs includes job candidates that applied for each one of the plurality of jobs.

16. The method of claim 1, wherein the set of job candidates for each one of the plurality of jobs includes job candidates that the processor determined are qualified for each one for the plurality of jobs.

17. The method of claim 15, wherein the set of job candidates for each one of the plurality of jobs includes job candidates that the processor determined are qualified for each one of the plurality of jobs.
